(19) United States
(12) Patent Application Publication
(10) Pub. No.: US 2006/0291835 A1
(43) Pub. Date: Dec. 28, 2006

(54) Susceptor for heat treatment and heat treatment apparatus

(75) Inventors: Yoshihide Nozaki, Kyoto (JP); Hideo Nishihara, Kyoto (JP); Hiroki Kiyama, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg., Co., Ltd.

(21) Appl. No.: 11/473,847

(22) Filed: Jun. 23, 2006

(30) Foreign Application Priority Data
Jun. 23, 2005 (JP) JP2005-183229

(51) Int. Cl. A21B 2/00

(52) U.S. Cl. 392/416

(57) ABSTRACT

A susceptor for holding a semiconductor wafer when flash heating is performed by exposing the semiconductor wafer to a flash of light from flash lamps is formed with a recessed portion of a concave configuration having an outer diameter greater than the diameter of the semiconductor wafer, as seen in plan view. When the susceptor is viewed from above, the concave configuration of the recessed portion is greater in plan view size than the semiconductor wafer. The susceptor formed with the recessed portion holds the semiconductor wafer in such a manner that an inner wall surface of the recessed portion supports a peripheral portion of the semiconductor wafer. As a result, a gap filled with a layer of gas is formed between the lower surface of the semiconductor wafer and the upper surface of the susceptor, to prevent a crack in the semiconductor wafer when the semiconductor wafer is exposed to a flash of light from the flash lamps.

### BACKGROUND OF THE INVENTION

1. Field of the Invention

The present invention relates to a heat treatment susceptor for holding a substrate including a semiconductor wafer, a glass substrate for a liquid crystal display device and the like which is to be heat-treated during the heat treatment thereof, and a heat treatment apparatus including the heat treatment susceptor.

2. Description of the Background Art

Conventionally, a lamp annealer employing a halogen lamp has been typically used in the step of activating ions in a semiconductor wafer after ion implantation. Such a lamp annealer carries out the activation of ions in the semiconductor wafer by heating (or annealing) the semiconductor wafer to a temperature of, for example, about 1000° C. to about 1100° C. Such a heat treatment apparatus utilizes the energy of light emitted from the halogen lamp to raise the temperature of a substrate at a rate of about hundreds of degrees per second.

In recent years, with the increasing degree of integration of semiconductor devices, it has been desired to provide a shallower junction as the gate length decreases. It has turned out, however, that even the execution of the process of activating ions in a semiconductor wafer by the use of the above-mentioned lamp annealer which raises the temperature of the semiconductor wafer at a rate of about hundreds of degrees per second produces a phenomenon in which the ions of boron, phosphorus and the like implanted in the semiconductor wafer are diffused deeply by heat. The occurrence of such a phenomenon causes the depth of the junction to exceed a required level, giving rise to an apprehension about a hindrance to good device formation.

To solve the problem, there has been proposed a technique for exposing the surface of a semiconductor wafer to a flash of light by using a xenon flash lamp and the like to raise the temperature of only the surface of the semiconductor wafer implanted with ions in an extremely short time (several milliseconds or less). The xenon flash lamp has a spectral distribution of radiation ranging from ultraviolet to near-infrared regions. The wavelength of light emitted from the xenon flash lamp is shorter than that of light emitted from the conventional halogen lamp, and approximately coincides with a basic absorption band of a silicon semiconductor wafer. It is therefore possible to rapidly raise the temperature of the semiconductor wafer, with a small amount of light transmitted through the semiconductor wafer, when the semiconductor wafer is exposed to a flash of light emitted from the xenon flash lamp. Also, it has turned out that a flash of light emitted in an extremely short time of several milliseconds or less can achieve a selective temperature rise only near the surface of the semiconductor wafer. Therefore, the temperature rise in an extremely short time by using the xenon flash lamp allows the execution of only the ion activation without deeply diffusing the ions.

A heat treatment apparatus employing such a xenon flash lamp, which momentarily exposes the semiconductor wafer to light having ultrahigh energy, rapidly raises the surface temperature of the semiconductor wafer for a very short period of time, to cause the abrupt thermal expansion of the wafer surface, resulting in a high probability that a crack occurs in the semiconductor wafer. To solve the problem of such a crack peculiar to the heat treatment using the xenon flash lamp, for example, Japanese Patent Application Laid-Open No. 2004-179510 and Japanese Patent Application Laid-Open No. 2004-247339 disclose techniques in which a tapered portion is formed in a peripheral portion of a wafer pocket of a susceptor for holding a semiconductor wafer.

The use of the techniques disclosed in the above-mentioned cited documents has made it possible to prevent cracks in semiconductor wafers to a certain extent when the xenon flash lamp is used. The cracks, however, still occur with considerable frequency, depending on the types of semiconductor wafers and heat treatment conditions (preheating temperature, energy of light for exposure, and the like).

### SUMMARY OF THE INVENTION

The present invention is intended for a heat treatment susceptor for holding a substrate when heat treatment is performed on the substrate by exposing the substrate to a flash of light from at least one flash lamp.

According to the present invention, the heat treatment susceptor comprises: a holding surface for holding a substrate; and a recessed portion of a concave configuration provided in the holding surface, the recessed portion being greater in plan view size than the substrate, as seen in plan view.

The substrate is held in the recessed portion having the concave configuration greater in plan view size than the substrate as seen in plan view. As a result, a gap filled with a layer of gas is formed between the upper surface of the heat treatment susceptor and the lower surface of the substrate, to prevent a crack in the substrate when the substrate is exposed to a flash of light from the at least one flash lamp.

Preferably, the concave configuration as seen in sectional view taken along a vertical plane passing through the center of the recessed portion is a jagged and stair-step configuration.

This allows the formation of the concave configuration relatively easily.

The present invention is also intended for a heat treatment apparatus for exposing a substrate to a flash of light to heat the substrate.

According to the present invention, the heat treatment apparatus comprises: a) a light source including at least one flash lamp; b) a chamber provided under the light source and including a chamber window provided in an upper portion of the chamber, the chamber window allowing a flash of light emitted from the at least one flash lamp to travel therethrough; and c) a heat treatment susceptor for holding a substrate in a substantially horizontal position within the chamber, the heat treatment susceptor including c-1) a holding surface for holding a substrate, and c-2) a recessed portion of a concave configuration provided in the holding surface, the recessed portion being greater in plan view size than the substrate, as seen in plan view.

A gap filled with a layer of gas is formed between the upper surface of the heat treatment susceptor and the lower surface of the substrate, to prevent a crack in the substrate when the substrate is exposed to a flash of light from the at least one flash lamp.

It is therefore an object of the present invention to provide a heat treatment susceptor and a heat treatment apparatus which are capable of preventing a crack in a substrate when the substrate is exposed to a flash of light from a flash lamp.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a side sectional view showing the construction of a heat treatment apparatus according to the present invention;

FIG. 2 is a sectional view showing a gas passage in the heat treatment apparatus of FIG. 1;

FIG. 3 is a plan view showing a hot plate in the heat treatment apparatus of FIG. 1;

FIG. 4 is a side sectional view showing the construction of the heat treatment apparatus of FIG. 1;

FIG. 5 is a sectional view showing an example of a heat treatment susceptor;

FIG. 6 is a sectional view showing another example of the heat treatment susceptor according to the present invention;

FIG. 7 is a plan view showing the heat treatment susceptor of FIG. 6;

FIG. 8 is a sectional view showing still another example of the heat treatment susceptor according to the present invention; and

FIG. 9 is a plan view showing the heat treatment susceptor of FIG. 8.

### DESCRIPTION OF THE PREFERRED EMBODIMENTS

A preferred embodiment according to the present invention will now be described in detail with reference to the drawings.

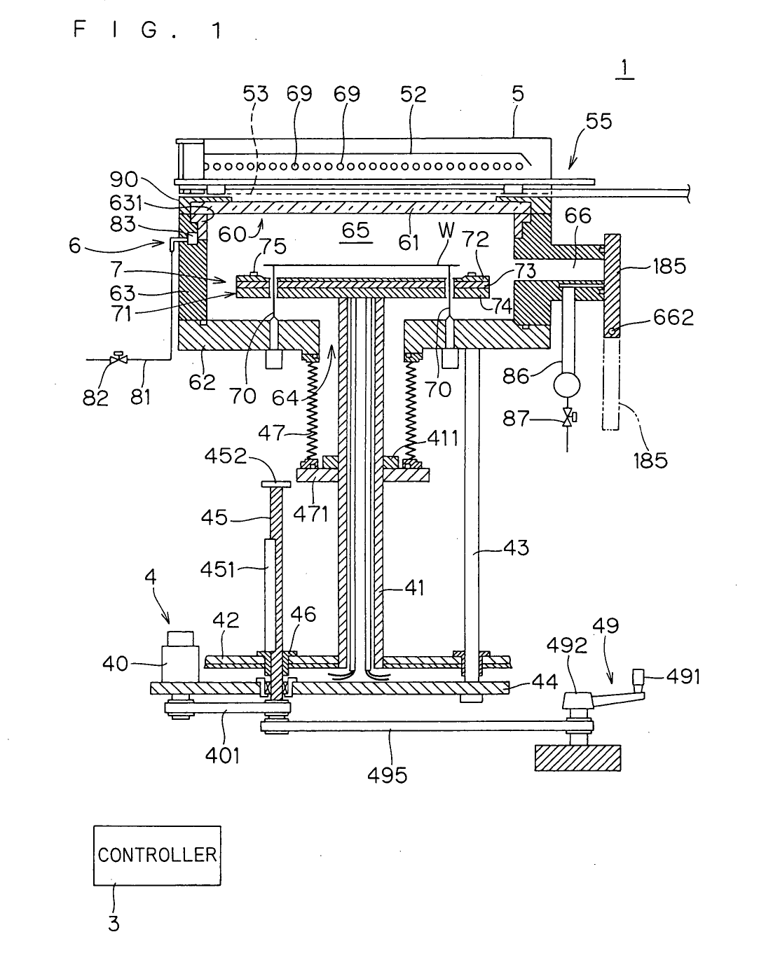

First, the overall construction of a heat treatment apparatus according to the present invention will be outlined. FIG. 1 is a side sectional view showing the construction of a heat treatment apparatus 1 according to the present invention. The heat treatment apparatus 1 is a flash lamp annealer for exposing a circular semiconductor wafer W serving as a substrate to a flash of light to heat the semiconductor wafer W.

The heat treatment apparatus 1 comprises a chamber 6 of a generally cylindrical configuration for receiving a semiconductor wafer W therein. The chamber 6 includes a chamber side portion 63 having an inner wall of a generally cylindrical configuration, and a chamber bottom portion 62 for covering a bottom portion of the chamber side portion 63. A space surrounded by the chamber side portion 63 and the chamber bottom portion 62 is defined as a heat treatment space 65. A top opening 60 is formed over the heat treatment space 65.

The heat treatment apparatus 1 further comprises: a light-transmittable plate 61 serving as a closure member mounted in the top opening 60 for closing the top opening 60; a holding part 7 of a generally disk-shaped configuration for preheating a semiconductor wafer W while holding the semiconductor wafer W within the chamber 6; a holding part elevating mechanism 4 for moving the holding part 7 upwardly and downwardly relative to the chamber bottom portion 62 serving as the bottom surface of the chamber 6; a light emitting part 5 for directing light through the light-transmittable plate 61 onto the semiconductor wafer W held by the holding part 7 to heat the semiconductor wafer W; and a controller 3 for controlling the above-mentioned components to perform heat treatment.

The chamber 6 is provided under the light emitting part 5. The light-transmittable plate 61 provided in an upper portion of the chamber 6 is a disk-shaped member made of, for example, quartz, and functions as a chamber window for allowing light emitted from the light emitting part 5 to travel therethrough into the heat treatment space 65. The chamber bottom portion 62 and the chamber side portion 63 which constitute the main body of the chamber 6 are made of a metal material having high strength and high heat resistance such as stainless steel and the like. A ring 631 provided in an upper portion of the inner side surface of the chamber side portion 63 is made of an aluminum (Al) alloy and the like having greater durability against degradation resulting from exposure to light than stainless steel.

An O-ring provides a seal between the light-transmittable plate 61 and the chamber side portion 63 so as to maintain the hermeticity of the heat treatment space 65. Specifically, the O-ring is fitted between a lower peripheral portion of the light-transmittable plate 61 and the chamber side portion 63, and a clamp ring 90 abuts against an upper peripheral portion of the light-transmittable plate 61 and is secured to the chamber side portion 63 by screws, thereby forcing the light-transmittable plate 61 against the O-ring.

The chamber bottom portion 62 is provided with a plurality of (in this preferred embodiment, three) upright support pins 70 extending through the holding part 7 for supporting the lower surface (a surface opposite from a surface onto which light is directed from the light emitting part 5) of the semiconductor wafer W. The support pins 70 are made of, for example, quartz, and are easy to replace because the support pins 70 are fixed externally of the chamber 6.

The chamber side portion 63 includes a transport opening 66 for the transport of the semiconductor wafer W therethrough into and out of the chamber 6. The transport opening 66 is openable and closable by a gate valve 185 pivoting about an axis 662. An inlet passage 81 for introducing a processing gas (for example, an inert gas including nitrogen (N₂) gas, helium (He) gas, argon (Ar) gas and the like, or oxygen (O₂) gas and the like) into the heat treatment space 65 is formed on the opposite side of the chamber side portion 63 from the transport opening 66. The inlet passage 81 has a first end connected through a valve 82 to a gas supply mechanism not shown, and a second end connected to a gas inlet buffer 83 formed inside the chamber side portion 63. The transport opening 66 is provided with an outlet passage 86 for exhausting the gas from the interior of the heat treatment space 65. The outlet passage 86 is connected through a valve 87 to an exhaust mechanism not shown.

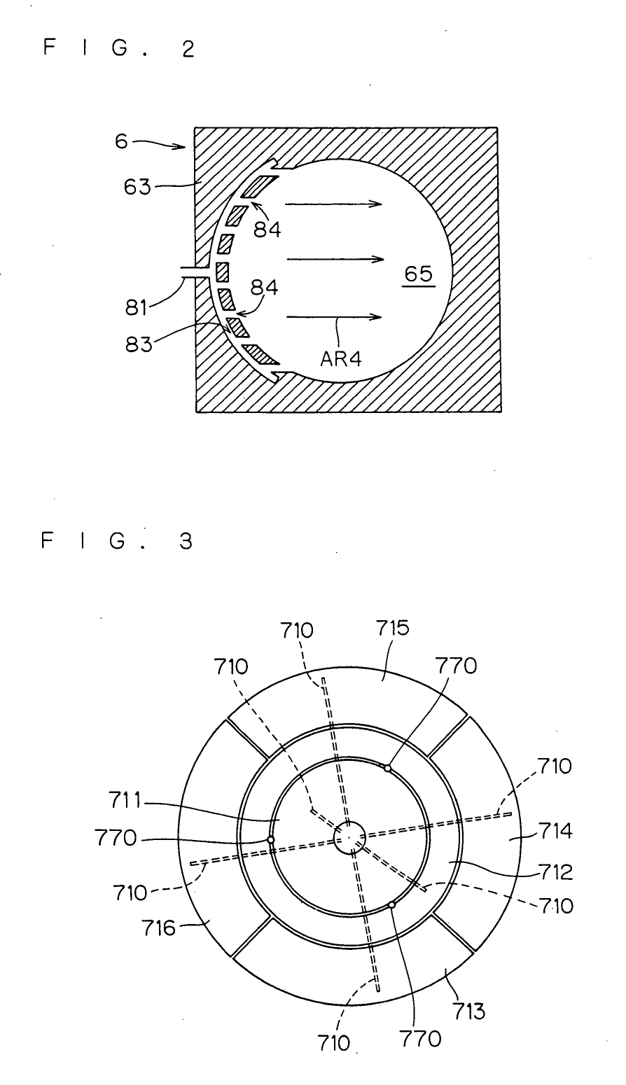

FIG. 2 is a sectional view of the chamber 6 taken along a horizontal plane at the level of the gas inlet buffer 83. As shown in FIG. 2, the gas inlet buffer 83 extends over approximately one-third of the inner periphery of the chamber side portion 63 on the opposite side from the transport opening 66 shown in FIG. 1. The processing gas introduced through the inlet passage 81 to the gas inlet buffer 83 is fed through a plurality of gas feed holes 84 into the heat treatment space 65.

The holding part elevating mechanism 4 shown in FIG. 1 includes a shaft 41 of a generally cylindrical configuration, a movable plate 42, guide members 43 (three guide members 43 are actually provided around the shaft 41 in this preferred embodiment), a fixed plate 44, a ball screw 45, a nut 46, and a motor 40. The chamber bottom portion 62 serving as the bottom portion of the chamber 6 is formed with a bottom opening 64 of a generally circular configuration having a diameter smaller than that of the holding part 7. The shaft 41 made of stainless steel is inserted through the bottom opening 64 and connected to the lower surface of the holding part 7 (a hot plate 71 of the holding part 7 in a strict sense) to support the holding part 7.

The nut 46 for threaded engagement with the ball screw 45 is fixed to the movable plate 42. The movable plate 42 is slidably guided by the guide members 43 fixed to the chamber bottom portion 62 and extending downwardly therefrom, and is vertically movable. The movable plate 42 is coupled through the shaft 41 to the holding part 7.

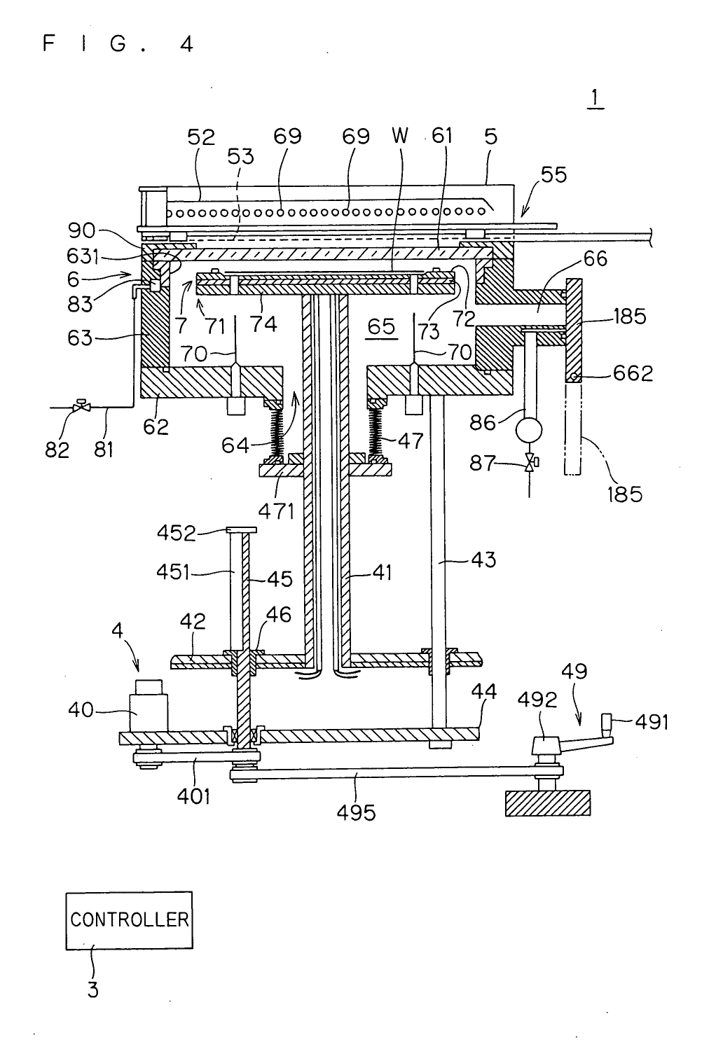

The motor 40 is provided on the fixed plate 44 mounted to the lower end portions of the respective guide members 43, and is connected to the ball screw 45 through a timing belt 401. When the holding part elevating mechanism 4 moves the holding part 7 upwardly and downwardly, the motor 40 serving as a driver rotates the ball screw 45 under the control of the controller 3 to move the movable plate 42 fixed to the nut 46 vertically along the guide members 43. As a result, the shaft 41 fixed to the movable plate 42 moves vertically, whereby the holding part 7 connected to the shaft 41 smoothly moves upwardly and downwardly between a transfer position shown in FIG. 1 in which the semiconductor wafer W is transferred and a heat treatment position shown in FIG. 4 in which the semiconductor wafer W is heat-treated.

An upright mechanical stopper 451 of a generally semi-cylindrical configuration (obtained by cutting a cylinder in half in a longitudinal direction) is provided on the upper surface of the movable plate 42 so as to extend along the ball screw 45. If the movable plate 42 is to move upwardly beyond a predetermined upper limit because of any anomaly, the upper end of the mechanical stopper 451 strikes an end plate 452 provided at an end portion of the ball screw 45, whereby the abnormal upward movement of the movable plate 42 is prevented. This avoids the upward movement of the holding part 7 above a predetermined position lying under the light-transmittable plate 61, to thereby prevent a collision between the holding part 7 and the light-transmittable plate 61.

The holding part elevating mechanism 4 further includes a manual elevating part 49 for manually moving the holding part 7 upwardly and downwardly during the maintenance of the interior of the chamber 6. The manual elevating part 49 has a handle 491 and a rotary shaft 492. Rotating the rotary shaft 492 by means of the handle 491 causes the rotation of the ball screw 45 connected through a timing belt 495 to the rotary shaft 492, thereby moving the holding part 7 upwardly and downwardly.

An expandable/contractible bellows 47 surrounding the shaft 41 and extending downwardly from the chamber bottom portion 62 is provided under the chamber bottom portion 62, and has an upper end connected to the lower surface of the chamber bottom portion 62. The bellows 47 has a lower end mounted to a bellows lower end plate 471. The bellows lower end plate 471 is screw-held and mounted to the shaft 41 by a collar member 411. The bellows 47 contracts when the holding part elevating mechanism 4 moves the holding part 7 upwardly relative to the chamber bottom portion 62, and expands when the holding part elevating mechanism 4 moves the holding part 7 downwardly. When the holding part 7 moves upwardly and downwardly, the bellows 47 contracts and expands to maintain the heat treatment space 65 hermetically sealed.

The holding part 7 includes the hot plate (or heating plate) 71 for preheating (or assist-heating) the semiconductor wafer W, and a susceptor 72 provided on the upper surface (a surface on which the holding part 7 holds the semiconductor wafer W) of the hot plate 71. The shaft 41 for moving the holding part 7 upwardly and downwardly as mentioned above is connected to the lower surface of the holding part 7. The susceptor 72 is made of quartz (or may be made of aluminum nitride (AlN) or the like). Pins 75 for preventing the semiconductor wafer W from shifting out of place are mounted on the upper surface of the susceptor 72. The susceptor 72 is provided on the hot plate 71, with the lower surface of the susceptor 72 in face-to-face contact with the upper surface of the hot plate 71. Thus, the susceptor 72 diffuses heat energy from the hot plate 71 to transfer the heat energy to the semiconductor wafer W placed on the upper surface of the susceptor 72, and is removable from the hot plate 71 for cleaning during maintenance.

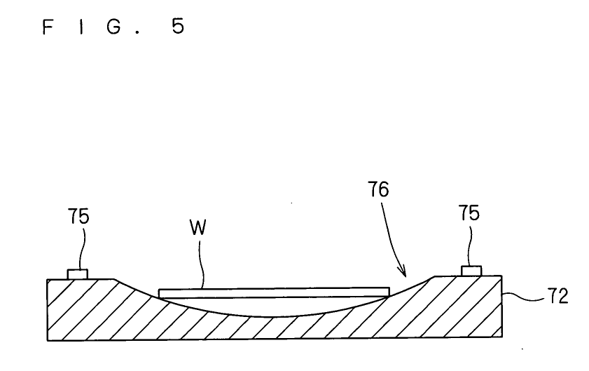

FIG. 5 is a sectional view of the susceptor 72 corresponding to a heat treatment susceptor according to the present invention. The susceptor 72 is formed with a recessed portion 76 of a concave configuration having an outer diameter greater than the diameter of the semiconductor wafer W, as seen in plan view. In other words, when the susceptor 72 is viewed from above, the concave configuration of the recessed portion 76 is greater in plan view size than the semiconductor wafer W. The concave configuration defining the recessed portion 76 has a predetermined radius of curvature.

The susceptor 72 formed with such a recessed portion 76 holds the semiconductor wafer W in such a manner that an inner wall surface of the recessed portion 76 supports a peripheral portion of the semiconductor wafer W, as shown in FIG. 5. As a result, a gap filled with a layer of gas is formed between the lower surface of the semiconductor wafer W and the upper surface of the susceptor 72.

The hot plate 71 includes an upper plate 73 and a lower plate 74 both made of stainless steel. Resistance heating wires such as nichrome wires for heating the hot plate 71 are provided between the upper plate 73 and the lower plate 74, and an electrically conductive brazing metal containing nickel (Ni) fills the space between the upper plate 73 and the lower plate 74 to seal the resistance heating wires therewith. The upper plate 73 and the lower plate 74 have brazed or soldered ends.

FIG. 3 is a plan view of the hot plate 71. As shown in FIG. 3, the hot plate 71 has a circular zone 711 and an annular zone 712 arranged in concentric relation with each other and positioned in a central portion of a region opposed to the semiconductor wafer W held by the holding part 7, and four zones 713 to 716 into which a substantially annular region surrounding the zone 712 is circumferentially equally divided. Slight gaps are formed between these zones 711 to 716. The hot plate 71 is provided with three through holes 770 receiving the respective support pins 70 therethrough and circumferentially spaced 120° apart from each other in a gap between the zones 711 and 712.

In the six zones 711 to 716, the resistance heating wires independent of each other are disposed so as to make a circuit to form heaters, respectively. The heaters incorporated in the respective zones 711 to 716 individually heat the respective zones 711 to 716. The semiconductor wafer W held by the holding part 7 is heated by the heaters incorporated in the six zones 711 to 716. A sensor 710 for measuring the temperature of each zone by using a thermocouple is provided in each of the zones 711 to 716. The sensors 710 pass through the interior of the generally cylindrical shaft 41 and are connected to the controller 3.

For heating the hot plate 71, the controller 3 controls the amount of power supply to the resistance heating wires provided in the respective zones 711 to 716 so that the temperatures of the six zones 711 to 716 measured by the sensors 710 reach a previously set predetermined temperature. The temperature control in each zone by the controller 3 is PID (Proportional, Integral, Derivative) control. In the hot plate 71, the temperatures of the respective zones 711 to 716 are continually measured until the heat treatment of the semiconductor wafer W (the heat treatment of all semiconductor wafers W when the plurality of semiconductor wafers W are successively heat-treated) is completed, and the amounts of power supply to the resistance heating wires provided in the respective zones 711 to 716 are individually controlled, that is, the temperatures of the heaters incorporated in the respective zones 711 to 716 are individually controlled, whereby the temperatures of the respective zones 711 to 716 are maintained at the set temperature. The set temperature for the zones 711 to 716 may be changed by an individually set offset value from a reference temperature.

The resistance heating wires provided in the six zones 711 to 716 are connected through power lines passing through the interior of the shaft 41 to a power source (not shown). The power lines extending from the power source to the zones 711 to 716 are disposed inside a stainless tube filled with an insulator of magnesia (magnesium oxide) or the like so as to be electrically insulated from each other. The interior of the shaft 41 is open to the atmosphere.

The light emitting part 5 shown in FIG. 1 is a light source including a plurality of (in this preferred embodiment, 30) xenon flash lamps (referred to simply as “flash lamps” hereinafter) 69, and a reflector 52. The plurality of flash lamps 69 each of which is a rodlike lamp having an elongated cylindrical configuration are arranged in a plane so that the longitudinal directions of the respective flash lamps 69 are in parallel with each other along a major surface of the semiconductor wafer W held by the holding part 7. The reflector 52 is provided over the plurality of flash lamps 69 to cover all of the flash lamps 69. The surface of the reflector 52 is roughened by abrasive blasting to produce a stain finish thereon. A light diffusion plate 53 (or a diffuser) is made of quartz glass having a surface subjected to a light diffusion process, and is provided on the lower surface side of the light emitting part 5, with a predetermined spacing held between the light diffusion plate 53 and the light-transmittable plate 61. The heat treatment apparatus 1 further comprises an emitting part movement mechanism 55 for moving the light emitting part 5 upwardly relative to the chamber 6 and then for sliding the light emitting part 5 in a horizontal direction during maintenance.

Each of the xenon flash lamps 69 includes a glass tube containing xenon gas sealed therein and having positive and negative electrodes provided on opposite ends thereof and connected to a capacitor, and a trigger electrode wound on the outer peripheral surface of the glass tube. Because the xenon gas is electrically insulative, no current flows in the glass tube in a normal state. However, if a high voltage is applied to the trigger electrode to produce an electrical breakdown, electricity stored in the capacitor flows momentarily in the glass tube, and the Joule heat evolved at this time heats the xenon gas to cause light emission. The xenon flash lamps 69 have the property of being capable of emitting much intenser light than a light source that stays lit continuously because previously stored electrostatic energy is converted into an ultrashort light pulse ranging from 0.1 millisecond to 10 milliseconds.

The heat treatment apparatus 1 according to this preferred embodiment includes various cooling structures (not shown) to prevent an excessive temperature rise in the chamber 6 and the light emitting part 5 because of the heat energy generated from the flash lamps 69 and the hot plate 71 during the heat treatment of the semiconductor wafer W. As an example, the chamber side portion 63 and the chamber bottom portion 62 of the chamber 6 are provided with a water cooling tube, and the light emitting part 5 is provided with a supply pipe for supplying a gas to the interior thereof and an exhaust pipe with a silencer to form an air cooling structure. Compressed air is supplied to the gap between the light-transmittable plate 61 and (the light diffusion plate 53 of) the light emitting part 5 to cool down the light emitting part 5 and the light-transmittable plate 61 and to remove organic materials and the like present in the gap therefrom to suppress the deposition of the organic materials and the like to the light diffusion plate 53 and the light-transmittable plate 61 during the heat treatment.

Next, a procedure for treating the semiconductor wafer W in the heat treatment apparatus 1 will be briefly described. The semiconductor wafer W to be treated herein is a semiconductor substrate doped with impurities by an ion implantation process. The activation of the implanted impurities is achieved by the heat treatment of the heat treatment apparatus 1.

First, the holding part 7 is placed in a position close to the chamber bottom portion 62, as shown in FIG. 1. The position of the holding part 7 shown in FIG. 1 within the chamber 6 is referred to hereinafter as a “transfer position.” When the holding part 7 is in the transfer position, the upper ends of the support pins 70 protrude through the holding part 7 upwardly out of the holding part 7.

Next, the valve 82 and the valve 87 are opened to introduce nitrogen gas at room temperature into the heat treatment space 65 of the chamber 6. Subsequently, the transport opening 66 is opened, and a transport robot outside the apparatus transports the ion-implanted semiconductor wafer W through the transport opening 66 into the chamber 6 and places the semiconductor wafer W onto the plurality of support pins 70.

The amount of nitrogen gas fed into the chamber 6 during the transport of the semiconductor wafer W into the chamber 6 shall be about 40 liters per minute. The nitrogen gas fed in the chamber 6 flows from the gas inlet buffer 83 in a direction indicated by the arrow AR4 of FIG. 2, and is exhausted through the outlet passage 86 and the valve 87 shown in FIG. 1 by using a utility exhaust system. Part of the nitrogen gas fed into the chamber 6 is also exhausted from an exhaust port (not shown) provided inside the bellows 47. In steps to be described below, the nitrogen gas always continues to be fed into and exhausted from the chamber 6, and the amount of nitrogen gas fed into the chamber 6 is changed to various amounts in accordance with the process steps of the semiconductor wafer W.

After the semiconductor wafer W is transported into the chamber 6, the gate valve 185 closes the transport opening 66. Next, as shown in FIG. 4, the holding part elevating mechanism 4 moves the holding part 7 upwardly to a position (referred to hereinafter as a “heat treatment position”) close to the light-transmittable plate 61. Then, the semiconductor wafer W is transferred from the support pins 70 to the susceptor 72 of the holding part 7, and is held within the recessed portion 76 of the susceptor 72. At this time, the inner wall surface of the recessed portion 76 of the susceptor 72 supports the peripheral portion of the semiconductor wafer W.

Each of the six zones 711 to 716 of the hot plate 71 is already heated up to a predetermined temperature by the resistance heating wire individually provided within each of the zones 711 to 716 (between the upper plate 73 and the lower plate 74). The holding part 7 is moved upwardly to the heat treatment position and the semiconductor wafer W comes in contact with the holding part 7, whereby the semiconductor wafer W is preheated and the temperature of the semiconductor wafer W increases gradually.

Preheating the semiconductor wafer W in the heat treatment position for about 60 seconds increases the temperature of the semiconductor wafer W up to a previously set preheating temperature T1. The preheating temperature T1 shall range from about 200° C. to about 600° C., preferably from about 350° C. to about 550° C., at which there is no apprehension that the impurities implanted in the semiconductor wafer W are diffused by heat. A distance between the holding part 7 and the light-transmittable plate 61 is adjustable to any value by controlling the amount of rotation of the motor 40 of the holding part elevating mechanism 4.

After a lapse of the preheating time of about 60 seconds, a flash of light is emitted from the light emitting part 5 toward the semiconductor wafer W under the control of the controller 3 while the holding part 7 remains in the heat treatment position. Part of the light emitted from the flash lamps 69 of the light emitting part 5 travels directly to the interior of the chamber 6. The remainder of the light is reflected by the reflector 52, and the reflected light travels to the interior of the chamber 6. Such emission of the flash of light achieves the flash heating of the semiconductor wafer W. The flash heating, which is achieved by the emission of a flash of light from the flash lamps 69, can raise the surface temperature of the semiconductor wafer W in a short time.

Specifically, the light emitted from the flash lamps 69 of the light emitting part 5 is an intense flash of light emitted for an extremely short period of time ranging from about 0.1 millisecond to about 10 milliseconds because the previously stored electrostatic energy is converted into such an ultrashort light pulse. The surface temperature of the semiconductor wafer W subjected to the flash heating by the emission of the flash of light from the flash lamps 69 momentarily rises to a heat treatment temperature T2 of about 1000° C. to about 1100° C. After the impurities implanted in the semiconductor wafer W are activated, the surface temperature decreases rapidly. Because of the capability of increasing and decreasing the surface temperature of the semiconductor wafer W in an extremely short time, the heat treatment apparatus 1 can achieve the activation of the impurities while suppressing the diffusion of the impurities implanted in the semiconductor wafer W due to heat. Such a diffusion phenomenon is also known as a round or dull profile of the impurities implanted in the semiconductor wafer W. Because the time required for the activation of the implanted impurities is extremely short as compared with the time required for the thermal diffusion of the implanted impurities, the activation is completed in a short time ranging from about 0.1 millisecond to about 10 milliseconds during which no diffusion occurs.

Preheating the semiconductor wafer W by the holding part 7 prior to the flash heating allows the emission of the flash of light from the flash lamps 69 to rapidly increase the surface temperature of the semiconductor wafer W up to the heat treatment temperature T2.

After waiting in the heat treatment position for about 10 seconds following the completion of the flash heating, the holding part 7 is moved downwardly again to the transfer position shown in FIG. 1 by the holding part elevating mechanism 4, and the semiconductor wafer W is transferred from the holding part 7 to the support pins 70. Subsequently, the gate valve 185 opens the transport opening 66 having been closed, and the transport robot outside the apparatus transports the semiconductor wafer W placed on the support pins 70 outwardly. Thus, the flash heating process of the semiconductor wafer W in the heat treatment apparatus 1 is completed.

As discussed above, the nitrogen gas is continuously fed to the chamber 6 during the heat treatment of the semiconductor wafer W in the heat treatment apparatus 1. The amount of nitrogen gas fed into the chamber 6 shall be about 30 liters per minute when the holding part 7 is in the heat treatment position, and be about 40 liters per minute when the holding part 7 is in other than the heat treatment position.

In this preferred embodiment, when the flash lamps 69 emit a flash of light, the semiconductor wafer W to be heat-treated is held in the recessed portion 76 of the concave configuration which is greater in plan view size than the semiconductor wafer W, as seen in plan view. The exposure of the semiconductor wafer W to a flash of light with the semiconductor wafer W held in the recessed portion 76 of such a concave configuration has achieved the remarkable decrease in the frequency of the occurrence of cracks in wafers. For comparison, the present inventors executed the process of directing a flash of light from the flash lamps 69 onto bare wafers (or unpattemed wafers) held on a susceptor having an upper surface of a convex configuration. As a result, cracks occurred in the wafers with a frequency of approximately 50%. On the other hand, when the present inventors executed the process of directing a flash of light from the flash lamps 69 onto bare wafers held on the susceptor 72 formed with the recessed portion 76 of this preferred embodiment under the same conditions, no cracks occurred in 100 bare wafers. The frequency with which cracks occurred in wafers when a flash of light was directed from the flash lamps 69 onto bare wafers held on a susceptor having an upper surface of a flat configuration or a susceptor of the type conventionally used was approximately intermediate between that obtained from the susceptor having the upper surface of the convex configuration and that obtained from the susceptor having the upper surface of the concave configuration.

The process of directing a flash of light onto a semiconductor wafer W held on the susceptor 72 formed with the recessed portion 76 of the concave configuration is considered to achieve the significant reduction in the frequency with which cracks occur in wafers for the following reason. The temperature of the upper surface of the semiconductor wafer W subjected to the flash heating by the emission of the flash of light from the flash lamps 69 momentarily rises to the heat treatment temperature T2 of about 1000° C. to about 1100° C., whereas the temperature of the lower surface of the semiconductor wafer W at that moment does not rise so high from the preheating temperature T1 of about 350° C. to about 550° C. This causes the abrupt thermal expansion of only the upper surface of the semiconductor wafer W to warp the semiconductor wafer W so that the upper surface thereof is convex upward. In the next moment, the temperature of the upper surface of the semiconductor wafer W falls rapidly, whereas the temperature of the lower surface thereof rises slightly because of the transfer of heat from the upper surface to the lower surface. As a result, the upper surface of the semiconductor wafer W warped to be convex upward at the moment of the emission of the flash of light becomes unwarped. In reaction thereto, the semiconductor wafer W is further warped so that the lower surface thereof is convex downward. Then, the lower surface of the semiconductor wafer W collides violently with the susceptor surface if the semiconductor wafer W is held by the susceptor having a convex configuration or a flat configuration. This is considered to result in the increased frequency of the occurrence of cracks in wafers. On the other hand, when the semiconductor wafer W is held by the susceptor 72 formed with the recessed portion 76 of the concave configuration as in this preferred embodiment, the gap filled with a layer of gas is formed between the upper surface of the susceptor 72 and the lower surface of the semiconductor wafer W. This prevents the lower surface of the semiconductor wafer W from colliding with the upper surface of the susceptor 72 or reduces the impact, if the collision occurs, when the semiconductor wafer W is warped so that the lower surface thereof is convex downward immediately after the emission of the flash of light, to thereby significantly reducing the frequency of the occurrence of cracks in wafers.

When the semiconductor wafer W is held by the susceptor having the convex configuration, the semiconductor wafer W is point-supported at the apex of the convex surface. Thus, strong stress concentration occurs when the semiconductor wafer W is warped during the flash heating. This is considered to be a factor responsible for the increased frequency of the occurrence of cracks in wafers. The configuration as in the preferred embodiment, on the other hand, allows the inner wall surface of the recessed portion 76 to support the entire edge portion of the semiconductor wafer W, thereby alleviating the stress concentration when the semiconductor wafer W is warped during the flash heating. Consequently, the increase in the frequency of the occurrence of cracks in wafers is considered to be suppressed.

The reduction in the frequency of the occurrence of cracks in wafers during the flash heating in the above-mentioned manner achieves accordingly dramatic improvements in yield. Additionally, the emission of the flash of light from the flash lamps 69 with greater energy than in the background art achieves the promotion of a better activation process.

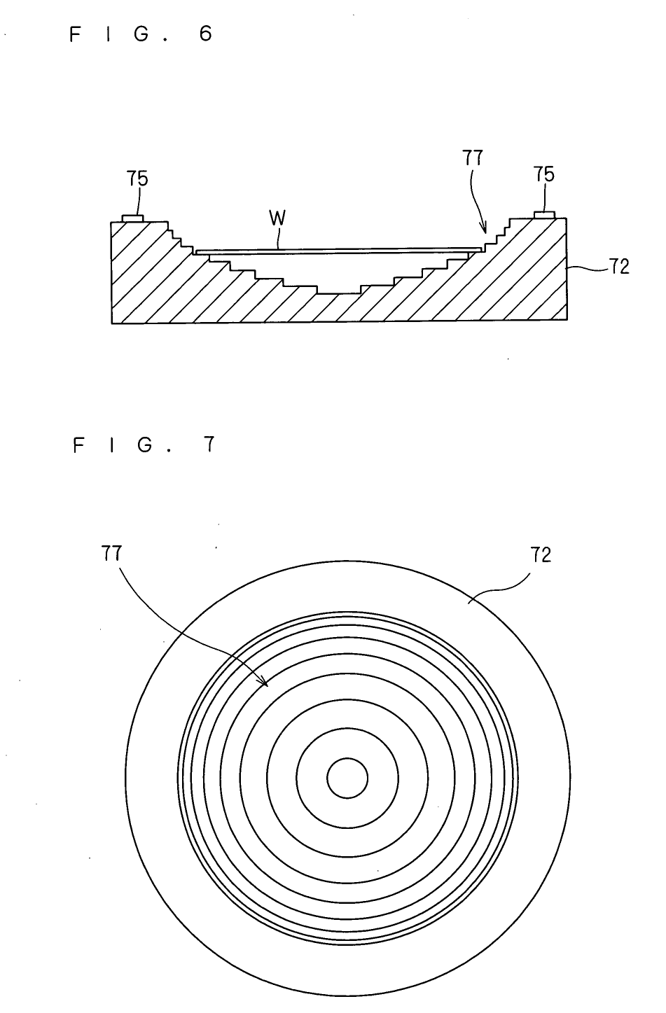

Although the above-mentioned preferred embodiment uses the susceptor 72 formed with the recessed portion 76 of the concave configuration which is greater in plan view size than the semiconductor wafer W, the susceptor 72 may have another configuration to be described below. FIG. 6 is a sectional view showing another example of the heat treatment susceptor according to the present invention. FIG. 7 is a plan view showing the heat treatment susceptor of FIG. 6. The susceptor 72 shown in FIGS. 6 and 7 is formed with a recessed portion 77 of a concave configuration having an outer diameter greater than the diameter of the semiconductor wafer W, as seen in plan view. The susceptor 72 shown in FIGS. 6 and 7 differs from the susceptor 72 shown in FIG. 5 in that the concave sectional configuration of the recessed portion 77 taken along a vertical plane passing through the center of the recessed portion 77 is not a smoothly concave configuration but is a jagged and stair-step configuration. The recessed portion 77, as viewed from above, presents a plurality of concentrically arranged annular stepped portions with increasing outer diameters and decreasing widths in an upward direction, as shown in FIG. 7. That is, the configuration of the recessed portion 77 can be regarded as a concave configuration from a macroscopic viewpoint, but can be regarded as a sectional configuration including successive stair-steps from a microscopic viewpoint. The stair-step configuration is shown in exaggeration in FIGS. 6 and 7 for ease of understanding of the configuration. Actually, the recessed portion 77 has a bowl-like configuration formed with smaller stepped portions. The smaller the stepped portions are, the closer to the concave configuration of FIG. 5 the configuration of the recessed portion 77 is.

The execution of the process of directing a flash of light from the flash lamps 69 onto a semiconductor wafer W held on the susceptor 72 formed with the recessed portion 77 as shown in FIGS. 6 and 7 forms a gap filled with a layer of gas between the upper surface of the susceptor 72 and the lower surface of the semiconductor wafer W in a manner similar to the above-mentioned preferred embodiment, to thereby significantly reduce the frequency of the occurrence of cracks in wafers. The material of the susceptor 72 is quartz (or ceramic such as aluminum nitride (AlN)) which is not so superior in workability. Thus, making the recessed portion 77 of the stair-step configuration is easier than forming a concave surface having a relatively large radius of curvature, and the recessed portion 77 can be manufactured relatively at low costs.

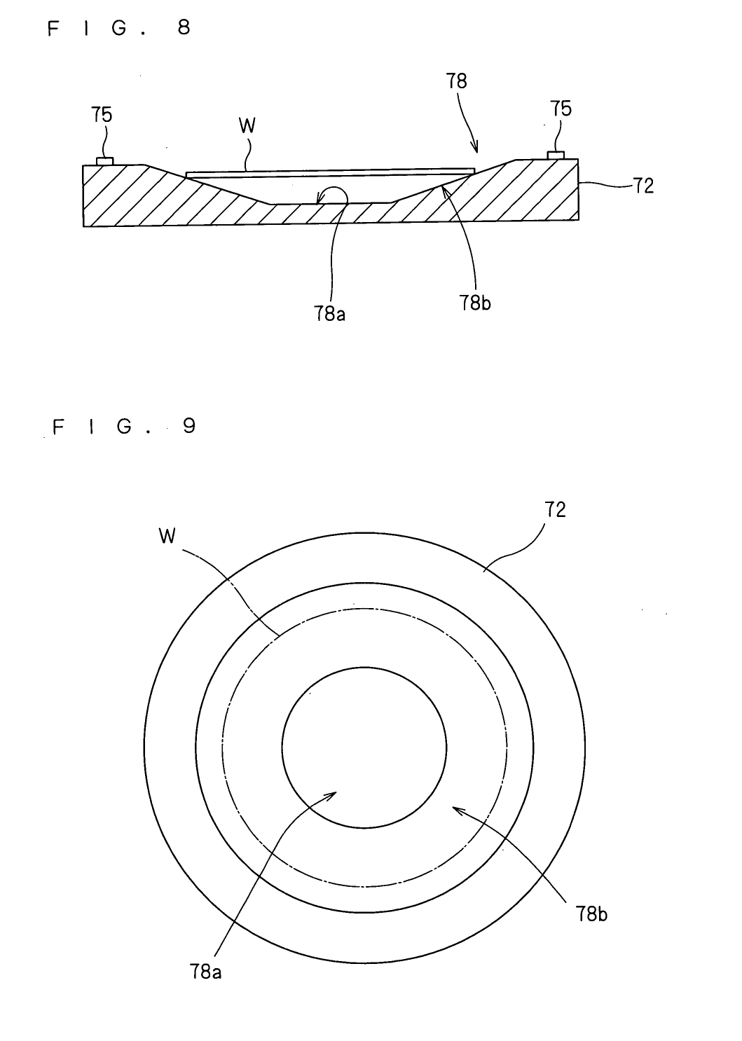

FIG. 8 is a sectional view showing still another example of the heat treatment susceptor according to the present invention. FIG. 9 is a plan view showing the heat treatment susceptor of FIG. 8. The susceptor 72 shown in FIGS. 8 and 9 is formed with a recessed portion 78 of a truncated conical configuration having an opening becoming wider in an upward direction. The truncated conical configuration has an upper large base (an opening surface of the recessed portion 78) greater in plan view size than the semiconductor wafer W, and a lower small base (a surface 78a of the recessed portion 78) smaller in plan view size than the semiconductor wafer W. The susceptor 72 formed with such a recessed portion 78 holds the semiconductor wafer W in such a manner that a tapered surface 78b of the recessed portion 78 supports the peripheral portion of the semiconductor wafer W, as shown in FIG. 8. As a result, a gap filled with a layer of gas is formed between the lower surface of the semiconductor wafer W and the upper surface of the susceptor 72.

The execution of the process of directing a flash of light from the flash lamps 69 onto a semiconductor wafer W held on the susceptor 72 formed with the recessed portion 78 as shown in FIGS. 8 and 9 forms the gap filled with a layer of gas between the upper surface of the susceptor 72 and the lower surface of the semiconductor wafer W in a manner similar to the above-mentioned preferred embodiment, to thereby significantly reduce the frequency of the occurrence of cracks in wafers. Because the truncated conical configuration is also relatively easy to work, the increase in manufacturing costs of the susceptor 72 is suppressed.

While the preferred embodiment according to the present invention has been described hereinabove, the present invention is not limited to the above-mentioned specific embodiment. Although the 30 flash lamps 69 are provided in the light emitting part 5 according to the above-mentioned preferred embodiment, the present invention is not limited to this. Any number of flash lamps 69 may be provided.

The flash lamps 69 are not limited to the xenon flash lamps but may be krypton flash lamps.

The hot plate 71 is used as the assist-heating element in the above-mentioned preferred embodiment. However, a group of lamps (e.g., a plurality of halogen lamps) may be provided under the holding part 7 which holds the semiconductor wafer W to emit light therefrom, thereby achieving the assist-heating.

When the holding part 7 receives the semiconductor wafer W from the support pins 70 prior to the flash heating, the speed of the upward movement of the holding part 7 may be reduced only at the moment of the receipt of the semiconductor wafer W, whereby the semiconductor wafer W is prevented from slipping sideways. However, few sideslips occur because the semiconductor wafer W is received by the recessed portion of the above-mentioned susceptor 72.

In the above-mentioned preferred embodiment, the ion activation process is performed by exposing the semiconductor wafer to light. The substrate to be treated by the heat treatment apparatus according to the present invention is not limited to the semiconductor wafer. For example, the heat treatment apparatus according to the present invention may perform the heat treatment on a glass substrate formed with various silicon films including a silicon nitride film, a polycrystalline silicon film and the like. As an example, silicon ions are implanted into a polycrystalline silicon film formed on a glass substrate by a CVD process to form an amorphous silicon film, and a silicon oxide film serving as an anti-reflection film is formed on the amorphous silicon film. In this state, the heat treatment apparatus according to the present invention may expose the entire surface of the amorphous silicon film to light to polycrystallize the amorphous silicon film, thereby forming a polycrystalline silicon film.

Another modification may be made in a manner to be described below. A TFT substrate is prepared such that an underlying silicon oxide film and a polysilicon film produced by crystallizing amorphous silicon are formed on a glass substrate and the polysilicon film is doped with impurities such as phosphorus or boron. The heat treatment apparatus according to the present invention may expose the TFT substrate to light to activate the impurities implanted in the doping step.

While the invention has been described in detail, the foregoing description is in all aspects illustrative and not restrictive. It is understood that numerous other modifications and variations can be devised without departing from the scope of the invention.

What is claimed is:

1. A heat treatment susceptor for holding a substrate when heat treatment is performed on the substrate by exposing the substrate to a flash of light from at least one flash lamp, said heat treatment susceptor comprising:
a holding surface for holding a substrate; and
a recessed portion of a concave configuration provided in said holding surface, said recessed portion being greater in plan view size than said substrate, as seen in plan view.

2. The heat treatment susceptor according to claim 1, wherein
said concave configuration as seen in sectional view taken along a vertical plane passing through the center of said recessed portion is a jagged and stair-step configuration.

3. The heat treatment susceptor according to claim 1, wherein
said recessed portion is of a bowl-like configuration.

4. A heat treatment susceptor for holding a substrate when heat treatment is performed on the substrate by exposing the substrate to a flash of light from at least one flash lamp, said heat treatment susceptor comprising:
a holding surface for holding a substrate; and
a recessed portion of a truncated conical configuration having an opening becoming wider in an upward direction,
said truncated conical configuration having an upper large base greater in plan view size than said substrate, and a lower small base smaller in plan view size than said substrate.

5. A heat treatment apparatus for exposing a substrate to a flash of light to heat the substrate, said heat treatment apparatus comprising:
a) a light source including at least one flash lamp;
b) a chamber provided under said light source and including a chamber window provided in an upper portion of said chamber, said chamber window allowing a flash of light emitted from said at least one flash lamp to travel therethrough; and
c) a heat treatment susceptor for holding a substrate in a substantially horizontal position within said chamber, said heat treatment susceptor including
c-1) a holding surface for holding a substrate, and
c-2) a recessed portion of a concave configuration provided in said holding surface, said recessed portion being greater in plan view size than said substrate, as seen in plan view.

6. The heat treatment apparatus according to claim 5, wherein
said concave configuration as seen in sectional view taken along a vertical plane passing through the center of said recessed portion is a jagged and stair-step configuration.

7. The heat treatment apparatus according to claim 5, wherein
said recessed portion is of a bowl-like configuration.

8. A heat treatment apparatus for exposing a substrate to a flash of light to heat the substrate, said heat treatment apparatus comprising:
a) a light source including at least one flash lamp;
b) a chamber provided under said light source and including a chamber window provided in an upper portion of said chamber, said chamber window allowing a flash of light emitted from said at least one flash lamp to travel therethrough; and
c) a heat treatment susceptor for holding a substrate in a substantially horizontal position within said chamber, said heat treatment susceptor including
c-1) a holding surface for holding a substrate, and
c-2) a recessed portion of a truncated conical configuration having an opening becoming wider in an upward direction,
said truncated conical configuration having an upper large base greater in plan view size than said substrate, and a lower small base smaller in plan view size than said substrate.
